(19) United States
(12) Patent Application Publication
(10) Pub. No.: US 2014/0289136 A1
(43) Pub. Date: Sep. 25, 2014

(54) Method of Appraising Rental Property

(71) Applicant: Gary M. Godbee, Peekskill, NY (US)

(72) Inventor: Gary M. Godbee, Peekskill, NY (US)

(21) Appl. No.: 14/222,714

(22) Filed: Mar. 24, 2014

Related U.S. Application Data
(60) Provisional application No. 61/804,393, filed on Mar. 22, 2013.

(51) Int. Cl. G06Q 30/02; G06Q 50/16

(52) U.S. Cl. CPC G06Q 30/0278; G06Q 50/16
USPC 705/306

(57) ABSTRACT

A method of appraising rental properties is provided that provides guidelines for government agency when determining rental subsidies to be paid to landlords and property owners. The method comprises cataloging and storing data related to the property and the tenants themselves, wherein the condition of the property, its amenities, the anticipated utilities for the property, and the local real estate market are accounted for in determining a reasonable rent to be paid to the landlord or property owner offering subsided housing to low income families. In carrying out the these objects, the present invention provides an application layer executed on a computer or other like programmable apparatus, a network, and a storage database for cataloging external data from public sources and from agency personnel directly. The method provides a reasonable rent calculation that is adapted to incentivize property owners to maintain their property and to prevent government agency waste.

This application claims the benefit of U.S. Provisional Application No. 61/804,393 filed on Mar. 22, 2013. The above identified patent application is herein incorporated by reference in its entirety to provide continuity of disclosure.

### BACKGROUND OF THE INVENTION

1. Field of the Invention

The present invention relates to methods of appraising residential housing units and apartments. More specifically, the present invention pertains to a new method of appraising rental values of those apartments and homes that receive government housing subsidies, thereby reducing waste and providing fair rental payments to landlords who provide public housing.

Federal housing assistance programs authorize subsidies to be paid to private landlords who provide low income housing to those in need. The tenant pays a share of the rental rate, and the government covers the unpaid monthly balance. This allows low income families to afford housing from private landlords, whereby the assistance is paid directly to the landlord. Tenants generally negotiate a lease with the property owner and pay a minimum of their income toward the monthly rent, whereafter the government pays the remainder. This form of housing subsidy has helped many individuals and families afford their rent, and prevents many from living in abject poverty or without a home.

In general, a governmental housing authority determines who qualifies for subsidized housing and how much a tenant pays based on their income. The difference between this amount and the market rate for the rental space is then paid directly to the landlord, who negotiates the rental value of the property with the housing authority. For those administering these programs, determining the rental value of multi-family apartment property or in dense public housing areas can be difficult. This can lead to under payments or over payments to the landlords, and therefore waste on the part of the housing authority or economic loss for private landlords.

Few methods currently exist for appraising rental values for apartment and public housing property. A common method of calculating rent includes using comparable rental values for similar properties in the same real estate market. However, some property owners, landlords, and government agencies arbitrarily assign values to their properties, even if the properties are not worth the assigned value. This forces tenants to pay a higher amount to make up the difference in what is not covered by the agency administering the assistance. This in turn forces many families out of some markets and places them in substandard housing in which their income can afford. When rental values are inflated, tenants are left without any way to enforce property improvement on the landlord, or are forced to pay more money than their property is worth

The rent paid to the owner of a property must be determined by the agency administering the funding. This requires the agency to determine a “reasonable rent” to be determined, which is generally based on comparability to rent for other comparable, unassisted housing units, or based on the property owner's certification that the rental rate being charged is comparable to unassisted units in the same premises. The present invention contemplates removing much of the uncertainty with regard to determining reasonable rent, and reduces many factors from different sources into an algorithm that provides an agency with a guideline for negotiating with property owners.

The present method comprises collecting data from outside sources and compiling them into a useful form such that a housing agency can quickly appraise a public housing unit and determine a reasonable rental value. The present invention has shown to be very accurate, providing a fair and reasonable rent to landlords, while also preventing waste on the part of the agency. The method comprises steps of collecting specific data related to the apartment or building, such as building feature factors, fair market rent, utility expenses, number of rooms, property features, and other data that is attainable through public sources or via in-person evaluations, and thereafter compiling the data. The information is arranged and entered into a reasonable rental formula, which provides an estimated residential value for the property based on the gathered data. This calculus helps to alleviate inconsistent, rampant, and uncontrolled rental rates, creates incentives for property owners or landlords to update their substandard properties, and improves living conditions for people affected by unequal rent determination. The method contemplates drawing from several public databases and drawing from data gathered via in-person evaluations, whereby the data is evaluated and transformed into a useful value used to eliminate economic waste or loss.

2. Description of the Prior Art

Devices have been disclosed in the prior art that relate to methods of compiling real estate data. These include devices that have been patented and published in patent application publications. These devices generally relate to compiling databases for real estate marking purposes or for viewing properties currently available for sale. The following is a list of devices deemed most relevant to the present disclosure, which are herein described for the purposes of highlighting and differentiating the unique aspects of the present invention, and further highlighting the drawbacks existing in the prior art.

U.S. Patent Publication No. 2003/0200151 to Ellenson discloses a system and method for real-time appraisal of used cars. A computer-based system is used to collect data supplied from buyers. A user enters in various factors in regards to a used vehicle to generate at least one guaranteed price for the used vehicle from appraisal an appraisal profile. The guaranteed price is generated from vehicle dealers in proximity to the user after the profile has been generated, thereby reducing anxiety and pressure related to selling a used car. The Ellenson invention, while disclosing an appraisal method and system, relates to vehicles and is not suitable for appraising rental values of real property as disclosed herein. While both the present invention and Ellenson desire a singular price, the manner in which the variables are derived to obtain a price for the property diverges significantly. Many of the inputs from the Ellenson method rely on user assessment of physical features of the vehicle. The present invention relies on expert assessor knowledge and data gathered from various public resources.

U.S. Pat. No. 5,794,216 to Brown discloses a method of compiling information about real estate using a computer readable storage medium, a computer, and memory. The method contemplates compiling a database of homes based on received textual and visual data related to the home for real estate marketing and information gathering purposes. The method compiles and stores the data related to the home for later retrieval and access, allowing users to view and see the attributes of the property both visually and textually. Similar to the Ellenson device, the Brown invention discloses a method related to real estate databases. The data is input into a database for the user to view pictures, data, and information related to homes in the database at a later time. The present invention pertains to a method of assessing the value of rental property using inputs from various government and public sources, including in-person evaluations of the property, whereby the inputs are used as factors to determine a reasonable rental price for the property. The present invention is not directed to a marketing tool or information database related to homes for sale, but rather a tool for assessors to obtain a reasonable rent for public housing, where government assistance is being provided.

U.S. Pat. No. 8,321,319 to Grossblatt discloses a method of analyzing a property for investment purposes, whereby an owner intends to rent the property and the method can be employed to analyze the investment potential. The method contemplates obtaining identifying information regarding the rental property, requesting and receiving rental data for comparable properties and price history of the property, as well as requesting and receiving tax and other relevant data related to the property to be rented. Prior to making the investment in the property, the method then adjusts the down payment amount, the mortgage information, and the inflation rate estimate to optimize the analysis result, resulting in an optimized analysis report for the potential investment property buyer. The Grossblatt method, while involving rental properties, is related to a calculus that provides an investor with a clearer view of a property of interest, wherein the investor can take into account an expected return on investment, how to finance the transaction, and also helps the investor understand the potential cash flow of the unit. It also provides. The present invention relates to assisted rental properties and ensuring fair rent is charged by a landlord to needy families, whereby both human assessor data and publically available data are drawn together in a database and compiled in a formula that outputs a reasonable rent.

The present invention is a tool for assessors, government agencies involved in public housing, and for landlords who may attempt to determine a reasonable rent on their own properties if leasing to families receiving assistance (Section 8 or equivalent). Disclosed is a method and system that is carried out by an application layer executed on a computer or other like programmable apparatus, whereby external data is gathered from government and public resources, as well as via direct input from a user. The data is compiled in a database, wherefrom factors are derived that are input into a calculation to determine a reasonable rent for a given property. Data of interest to the assessment and the present invention include the building features, fair market rent in the area, utility expenses, number of rooms, property features, and rating factors for the building quality. The method of the present invention attempts to curb uncontrolled and unfair rental rates and creates incentives for property owners or landlords to update their substandard properties, thereby improving living conditions for people in public housing situations that may otherwise be severely affected by improper rent determinations.

It has been shown that the prior art devices do not disclose the combination of steps or elements of the present invention, and that each of the identified prior art devices are ill-suited for determining a reasonable rent for use in the field of public housing. It is submitted that he present invention is substantially divergent in steps from the prior art, and furthermore that exits a need in the art for an improved method of determining reasonable rental rates for public housing and apartments rented to those receiving housing allowances. In this regard the instant invention substantially fulfills these needs.

### SUMMARY OF THE INVENTION

In view of the foregoing disadvantages inherent in the known types of real property appraisal methods now present in the prior art, the present invention provides a new appraisal method that is directed to determining reasonable rent for those properties which are offered to low income families and who receive housing subsidies from various government agencies, wherein waste, fraud, and property neglect are reduced.

It is therefore an object of the present invention to provide a new and improved appraisal method that has all of the advantages of the prior art and none of the disadvantages.

It is another object of the present invention to provide an public housing appraisal method that incorporates publically available data regarding the individual renter and the local real estate market, and combines data recorded by in person appraisals of the property in question to determine what is in fact a reasonable rent to be paid to the property owner or landlord.

Another object of the present invention is to provide a method that takes into consideration the quality of the property, its amenities, its condition, and its size in order to determine what is a reasonable rent.

Yet another object of the present invention is to provide a method that modifies the fair market rent calculated from external sources and increases or decreases the rental price using several factors gathered in person and via a system that catalogs publically available real estate and public housing data.

Another object of the present invention is to provide a method of appraisal for public housing that can be incorporated into the day to day operations of various government agencies administering public housing assistance, whereby the rental price can be more accurately aligned with the true condition of the property and the local real estate market.

Another object of the present invention is to provide a method of appraisal for public housing that can assist the agency administering the assistance when negotiating rental payments with landlords and property owners

Another object of the present invention is to provide a method of appraisal for public housing that incentivizes landlords and property owners to maintain their property, wherein the condition of the property and its amenities are incorporated in the reasonable rent calculus.

A final object of the present invention is to provide a method of appraising public housing that can be readily deployed on a personal computer, whereby an application layer thereon is an interface for inputting the variables of the method, and public data can be gathered over a network for incorporation.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates the system elements of the present invention, whereby a computer system is employed to receive inputs from the user and from external data sources, process the data and provide a useable output for the user.

FIG. 2 illustrates the steps of the present invention for loading and inputting information in the system, whereby the output comprises a calculated reasonable rent.

FIG. 3 is a table of fair market rental rates for a given property.

FIG. 4 is a table of in-person appraisal data of the property's indoor features cataloged in the system database.

FIG. 5 is a table of in-person appraisal data of the building's features cataloged in the system database.

FIG. 6 is a table in-person appraisal data of the exterior features cataloged in the system database.

FIG. 7 shows a list of amenities that can be cataloged and incorporated in the reasonable rent.

FIG. 8 shows the utility schedule of a given property, which can be cataloged and incorporated in the reasonable rent.

FIG. 9 is an equation utilized to weight the various factors of the property to derive a reasonable rent to offer a given property owner or landlord.

FIG. 10 is a sample layout of the property cataloged in the system database.

FIG. 11 is a reasonable rent review report, or output of the overall method.

### DETAILED DESCRIPTION OF THE INVENTION

Reference is made herein to the attached drawings. Like reference numerals are used throughout the drawings to depict like or similar elements of the public housing rent appraisal method of the present invention. For the purposes of presenting a brief and clear description of the present invention, the preferred embodiment will be discussed as used for appraising houses and apartments being rented to low income families and whose property owners receive government payments to subsidize the tenant's rent, whereby a reasonable rent is calculated to prevent waste, abuse of the program, and to incentivize maintenance and improvement of the property. The figures are intended for representative purposes only and should not be considered to be limiting in any respect.

The present invention describes a method for determining rent values for residential housing units or apartments. The method comprises the steps of collecting specific data, such as building, property and unit feature factors, fair market rent, utility expenses, and others, and compiling the data into a system for use in determining a reasonable rent for the unit. The information is combined on a system to estimate rent calculation, which outputs an estimated reasonable rent value for the given property that is more accurate than simply applying the fair market rent to the unit based on its location and size. The present method attempts to eliminate inconsistent, rampant, and uncontrolled rental rates, and creates incentives for property owners or landlords to update their substandard properties, while also improving the living conditions for people affected by unequal rent determination.

The disclosed method relies on a combination of human input and external data source input. The human input comprises traditional appraisal techniques employed by various government agency personnel who are employed to disperse public assistance for needy families or facilitate funding for rental housing. This includes appraisers who evaluate the condition and the state of the rental property and who use their independent experience and judgment in determining the value of specific properties. At the same time, the method contemplates retrieving external data from public and government sources, such as housing data and fair market rates from the U.S. Department of Housing and Urban Development (HUD) and other agencies or sources. The external sources are generally remote servers accessed over a network via a personal computer system (i.e. data that can be transmitted and downloaded via the internet over a given network). These inputs are used to determine a reasonable rent for a given property, whereby the condition of the property and the local real estate market are considered in the calculation.

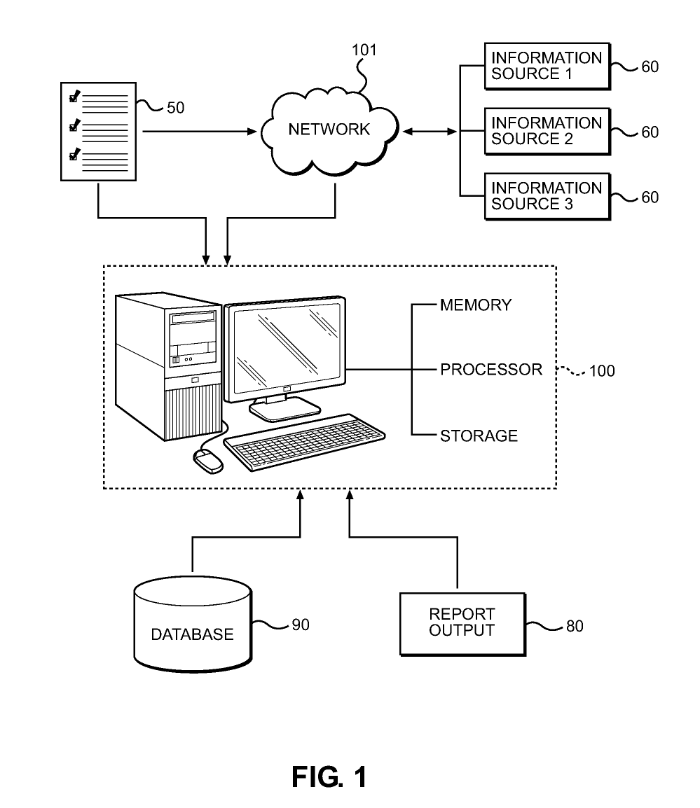

Referring now to FIG. 1, there is shown a system view of the present invention, wherein the objects of the method are carried out by an application layer executed on a computer 100 or other like programmable apparatus. The computer 100 comprises a terminal or workstation that is capable of receiving direct input from the user via peripherals (i.e. keyboard and mouse), while also being capable of connecting to a network 101 to obtain online and publically accessible information 60 from various remote servers. The computer itself comprises a processor or equivalent processing means, a computer memory (non-transitory computer-readable storage medium), and computer-readable storage medium. The storage supports computer-readable data to execute the prescribed method steps herein, to execute an application layer for the user to navigate, to receive and translate inputs, and to maintain network connectivity with external sources. The computer-readable data comprises an executable code and one or more databases for compiling textual information received via manual and external input.

The computer 100 is used to execute the method and receive data inputs, wherefrom the data is compiled, organized, and input into an overall calculation to determine an estimated rent for a given property. The estimated rent is used to propose a reasonable rental value to property owners and landlords when public assistance is being offered to cover a portion of the rent for low income families renting the owner's property. As stated, a first type of input is direct input 50 from the user, and is generally appraisal information and data gathered after an in-home inspection of the property by the agency personnel. As will be described below, various attributes of the property are recorded and evaluated, which in turn affect the reasonable rent offered to the property owner. In this way, it is intended that a landlord or property owner with knowledge that direct appraisal data will affect the rental rates of the property will be incentivized to maintain, improve, and add amenities to their property. In so doing, the owner or landlord thereby increases likelihood of a higher offered rent from the agency, while at the same time increasing the standard of living for the occupants thereof.

Equally important and useful to the direct input 50 and appraisal data to the system, is housing data and public information related to the given property and surrounding area. Various information sources 60 are accessed over a network (i.e. the internet) and are drawn upon to fill in required data for the estimated rent calculation. This data includes fair market rental data and public information about rental rates based on the local market. This information is retrieved over the network, compiled locally on the computer 100 or stored on a server or database 90, and then used as an input for the estimated rent calculation, as described below. The output is a report 80 of the specific property, its estimated rent, and a comparison to nearby properties and a comparison to the fair market rent thereof.

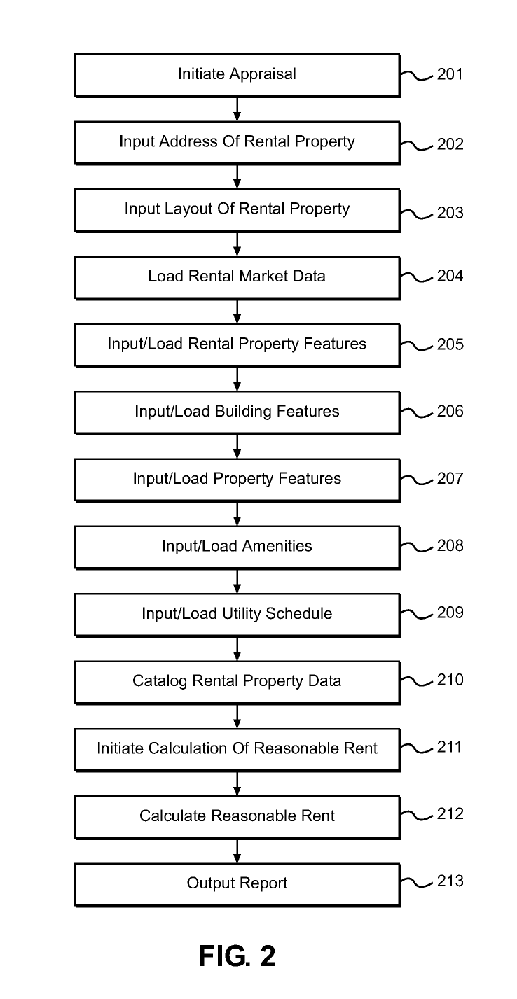

Referring now to FIG. 2, there is shown a flow chart that outlines the various steps of the present method in determining an estimated rent and in operating the disclosed system via an application layer, which executes the method thereon. To begin, a user engages the computer system and initiates the application layer, there by initiating 201 the method of inputting data into the system for appraising a specific property or unit. The address and location of the rental property is then entered 202, followed by a layout 203 of the property in question. The address information and layout may be derived from direct user input or via information readily available a network, if the property has already been cataloged elsewhere. Once the specific rental property data is entered, it can be saved onto a server or a database for subsequent retrieval.

After entry of the specific rental property data, fair market rental data is requested and loaded 204, and thereafter compiled and saved in connection with the rental property. This data is generally obtained from an external source, such as HUD or equivalent, or is input into the system by hand after the information is obtained. Externally loading this data is preferred, as it is more efficient and does not require human transcribing of the data across different mediums. The fair market rent is a data point for the rental price of the specific unit, and shows what equivalent homes in the local real estate market are worth in rent, based on location and rents for comparable homes.

After fair market rent is input into the system, data related to the specific property is input in the system and compiled. This includes the rental property unit features 205, the building features 206, the general property features 207, any amenities in the unit 208, and the anticipated utility schedule 209 for the unit. These data points are based on in-person appraising of the unit and the building, where the variables are given quality ratings. These variables are cataloged 210 and included in the calculation 211, 212 for determining estimated rent, wherein each factor in either raising or lowering the estimated rent with respect to the fair market rent for the same type of unit in the local area. Once the estimated rent is determined, an output report 213 is generated, comparing the estimated rent to comparable rentals in the area and listing the qualities of the specific unit.

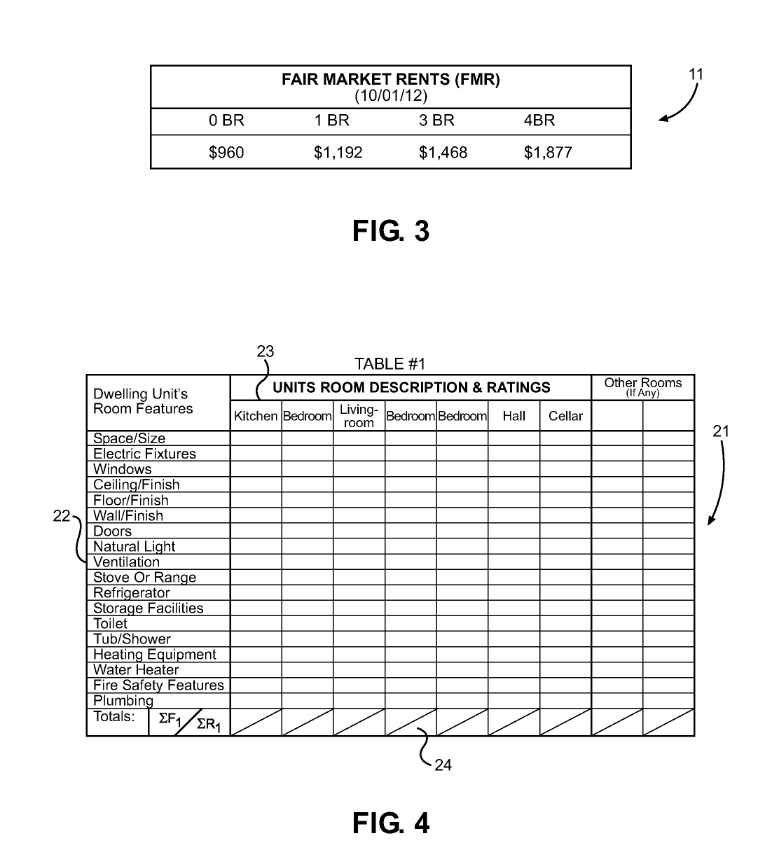

Referring now to FIG. 3 through 8, there are shown the various tables utilized to catalog both property-specific data and external property data, whereby the variables of the estimated rent calculation are derived and stored. Referring specifically to FIG. 3, there is shown a table of example fair market rental values as determined by HUD or an equivalent agency, wherein the data for a specific rental area is loaded from external information sources. The fair market rent (FMR) is used in the calculation to determine and estimated rent, and can vary from location to location depending on the cost of living in that area. The present invention incorporates various factors related to the condition and features of the rental property to adjust this fair market rent value, wherein those units with more features and in better condition are weighted higher, and vice versa. The FMR will be different for different markets, and furthermore takes into consideration the rental costs based on the size of the unit.

Referring specifically to FIG. 4, there is shown a view of Table #1, which is used during an in-person inspection or appraisal of the property. This table catalogs and quantifies the unit's features, whereby feature factors and the number thereof are derived for input into the calculation of estimated rent. The feature factors include a rating of each of the unit's areas 23, including the kitchen, bedrooms, living room areas, and other interior spaces. The quality of features within each of the unit areas 23 is quantified based on their condition and quantity, wherein a point system is used to quantify the quality and quantity of the features. Features, such as unit size, fixtures, ceiling/wall finish, etc. are provided with a point system based on the criteria listed below. A rating system of 1.0-0.5 is used to denote the quality of each of the features in the unit. As an example, a rating of 1.0 denotes that the feature is newly constructed or rehabilitated, while a score of 0.5 denotes that the feature is of unacceptable quality. The features are rated according to the rating criteria, which provide a value for each feature factors. Along the lower row 24 of Table 1, the rating criteria of each of the features 22 for each of the unit's areas 23 are summed to obtain a total feature factor rating criteria (ΣR₁), while the number of features 22 in each unit area 23 is also summed to obtain the total number of feature factors in the unit (ΣF₁). These variables serve as input into the estimated rent calculation. The ratings can also denote relative sizing of each of the unit's areas 23 when grading the space/size feature factor.

| Rating | |
|---|---|
| Criteria | Meaning |
| 1.0 | Denotes a feature newly constructed or rehabilitated in |
| | accordance with new construction standards |
| 0.9 | Denotes a feature that is partially (approximately 50%) |
| | rehabilitated in accordance with new construction standards or |
| | contains significant improvements |
| 0.8 | Denotes an existing feature that is maintained very well or above |
| | minimum standards |
| 0.7 | Denotes existing features maintained according to only very |
| | minimum standards |
| 0.6 | Denotes existing features maintained to only minimum standards |
| | and would like need continuous repetitive repairs or require |
| | improvements and upgrading thereof |
| 0.1-0.5 | Unacceptable |

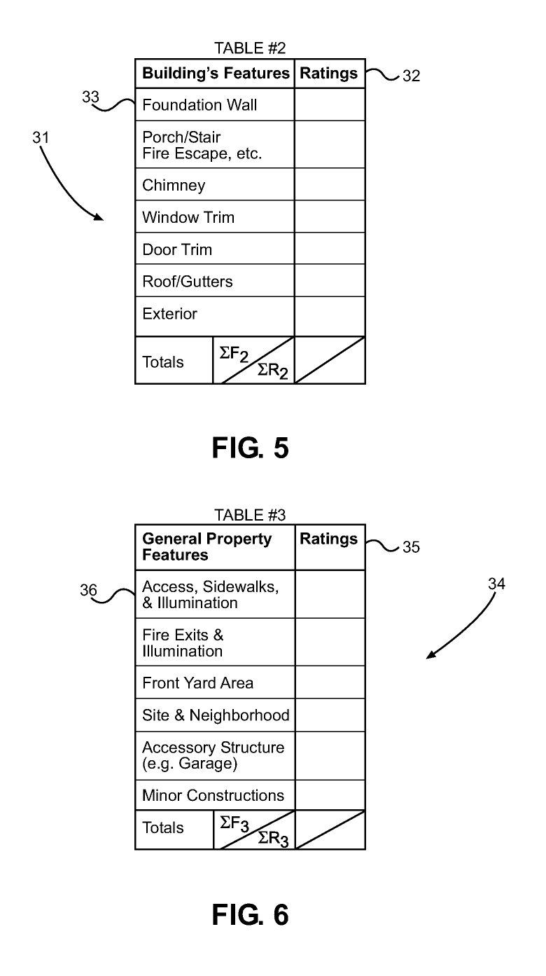

Referring now to FIGS. 5 and 6, there is shown Table #2 and Table #3 of the present method, wherein exterior factors of the property are graded and provided a rating to be incorporated in the estimated rent calculation. The exterior factors of the building are evaluated in a similar manner to the interior factors. The same rating system is used to denote the quality of exterior features 31, such as foundation walls 33, chimney, window/door trim, etc., as well as to rate the general property features 34, such as the areas 36 around the property. These tables are used to provide ratings 32, 35 that are totaled and incorporated into estimated rent calculation, whereby the general features 34 of the property and the building's features 31 are weighted against the fair market rent. Along the last row of each table, the sum of the building exterior feature factors ((ΣR₂), the number of exterior feature factors ((ΣF₂), and sum of the general property factors ((ΣR₃), and the total number thereof ((ΣF₃) are calculated.

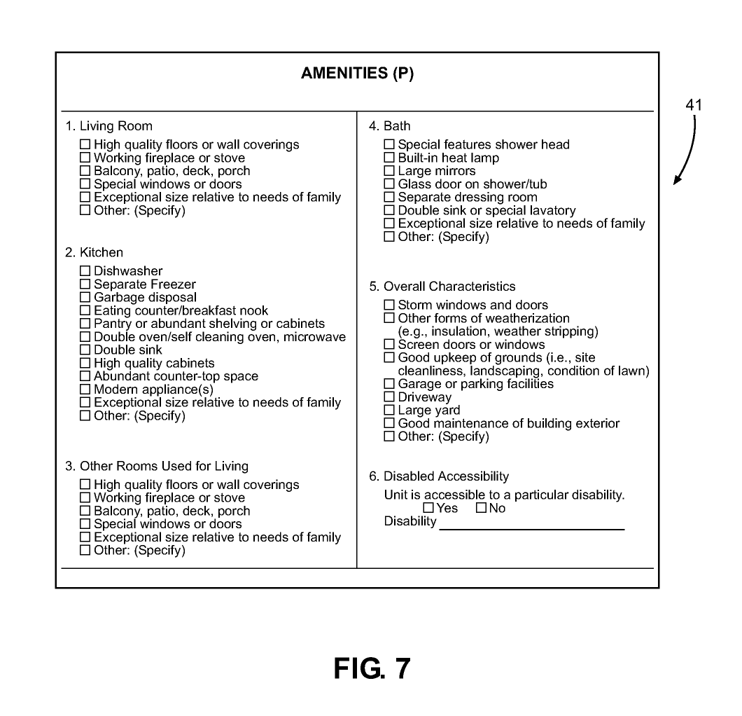

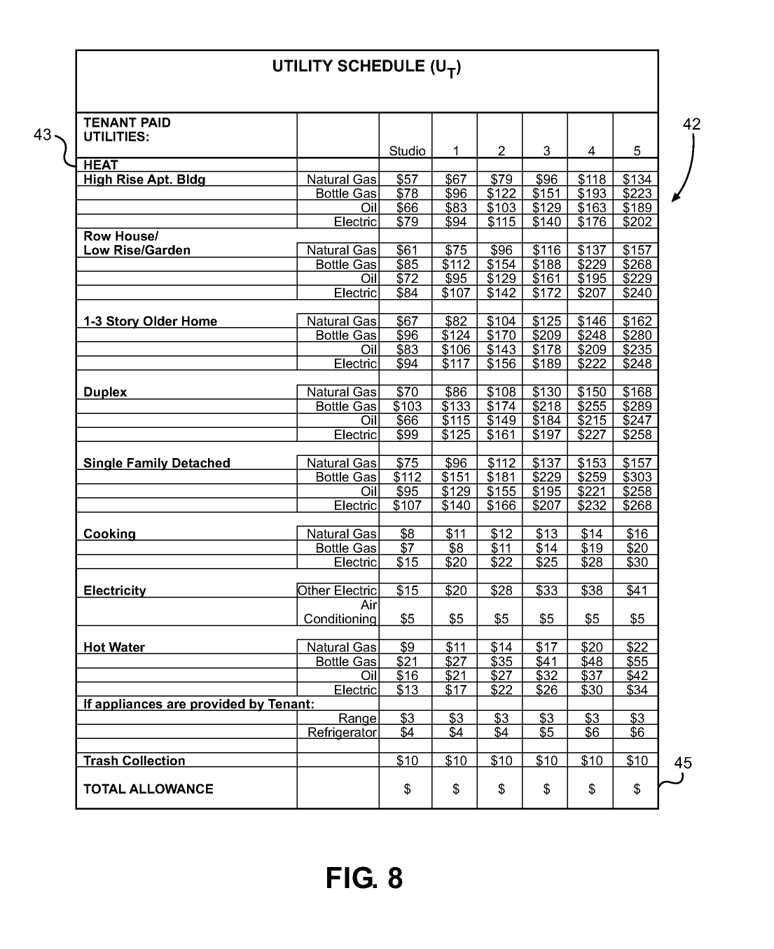

Referring now to FIGS. 7 and 8, there is shown two final tables in which the number of amenities (P) of the unit is recorded and the calculated utilities for the tenant (U_{T}) are tallied. The amenities table 41 takes into account the additional features of the unit, such as the appliances and other features that may otherwise not be graded when judging the construction and state of the unit. Those units with nice amenities, which are options that improve the standard of living of occupants, are incorporated in the calculation of estimated rent to take into account any upgrades in which the property owner has installed. Together with grading the structural features of the unit, grading amenities incentivizes activity on the part of the landlord to both maintain the unit and to offer improvements and upgrades over competing properties, as this will affect the rent given to the owner from the agency using the disclosed method. As with the exterior and interior feature factors, the amenities are appraised and graded in person by the user, whereby an in-person inspection of the property is conducted to tally the number of amenities in the unit. The number of amenities (P) are then input in the system and saved in a database file corresponding to the specific unit, as is done with the exterior and interior feature factors.

The utility schedule 42 as shown in FIG. 8 shows estimated utility costs for a given area based on the local standard of living and the size of the unit. This data is generated from an external source, wherein the source may be the same as that used to derive fair market rental values, or may be an alternate source. The utility schedule 42 lists estimated costs for utilities based on the type of building 43, the size of the specific unit, and the type of utilities that the building uses (i.e. gas, oil, electric, etc.). The various utilities for a given unit are chosen based on the type of building 42 and the size of the unit, wherein several utilities are total into a total utility allowance for the tenant (U_{T}). The utilities allowance is subtracted from the total utilities cost for the unit (U) to obtain a remainder, which is the property owner or landlord's utility expense obligation (Uₒ). The anticipated utility expense obligation is another variable that can be used to raise the estimated rental value, wherein property owners are compensated when the utility allowance rate is less than the actual utility costs of the unit, which would otherwise be an added expense to the owner or landlord.

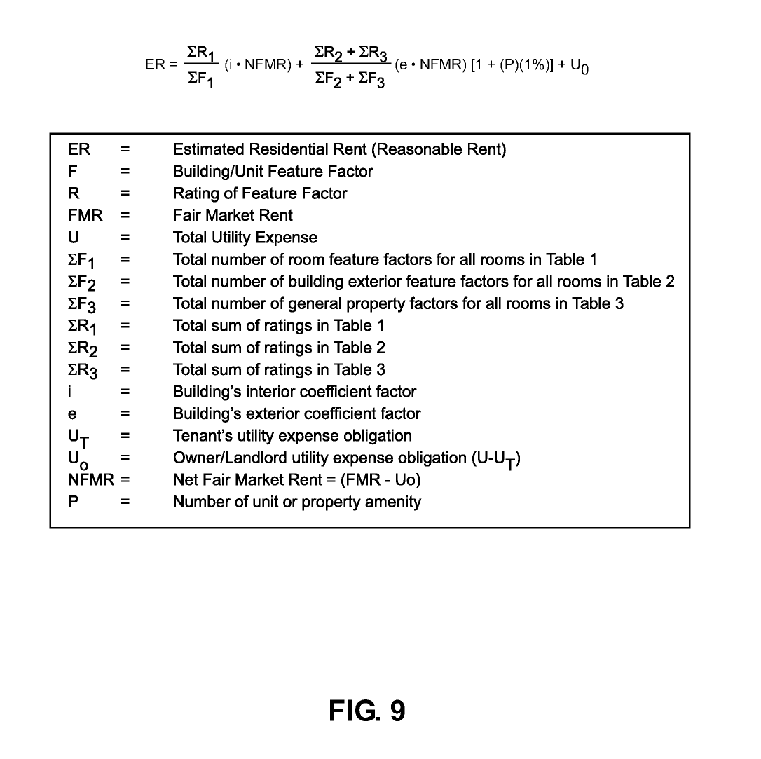

Turning to FIG. 9, there is shown a view of the appraisal formula of the present invention, wherein an estimated rent for a specific property is calculated after weighting the various factors of the method against the fair market rent thereof. Once all of the factors have been gathered and assigned a value, the Estimated Residential Rent (i.e. a reasonable rent) is then calculated based on the appraisal formula as provided. The formula is incorporated into a system that draws upon the various factors stored in databases in connection with a specific rental unit and outputs an estimated rent (ER). This calculus allows individuals and agencies to determine fair and accurate property values based on the actual condition of the unit, its upgrades, and its operating costs. This adjusts the fair market rent (FMR) to a more realistic rental value that reflects the condition and the upkeep of the unit, thereby placing an onus on the owner or landlord to maintain and upgrade the unit to obtain higher rental values, and vice versa. The formula provides incentives for property owners or landlords with substandard properties to raise the standard or quality of their respective property, and helps to prevent rent calculation based on arbitrary methods.

### Nomenclature for Estimated Rent Calculation

| Variable | Meaning |
|---|---|
| ER | Estimated Residential Rent |
| F | Building or Unit Feature Factor |
| R | Rating of Feature Factor |
| FMR | Fair Market Rent (Provided from government records for |
| | various unit sizes) |
| U | Total utility expense (provided by government records for |
| | units) |
| ΣF₁ | Total number of interior feature factors for all rooms listed in |
| | table #1 |
| ΣF₂ | Total number of building's exterior feature factors listed in |
| | table #2 |
| ΣF₃ | Total number of general property's feature factors listed in |
| | table #3 |
| ΣR₁ | Total sum of rating values listed in Table #1 |
| ΣR₂ | Total sum of rating values listed in Table #2 |
| ΣR₃ | Total sum of rating values listed in Table #3 |
| i | Building's interior coefficient factor = (60%) |
| e | Building's exterior coefficient factor = (40%) |
| UT | Tenant's utility expense obligation |
| Uₒ | Owner/Landlord utility expense obligation |
| NFMR | Net fair market rent (FMR-Uₒ) |
| P | Number of amenities |

When calculated using the prescribed formula, each unit or property amenity represents one (1) point, which equals 1% increase in rent value, while the interior and exterior factors are given a weighting factor that is chosen by the agency. The building's interior coefficient factor (i) and the building's exterior coefficient factor (e) can be set by the agency, whereby the weight given to these factors is controlled by an overall coefficient. The chosen values can range between 0.0-1.0, however generally a value of 0.60 and 0.40 for (i) and (e) have been shown to provide positive results for both property owners, renters, and agencies administering the program. However, these coefficient factors can be updated as desired. Similarly, the agency may also abridge the formula as desired, whereby utilities (U) may include the full utilities or none at all, and the amenities (P) may not be factored. This would reduce the calculation to a simpler form that does not take into account these factors.

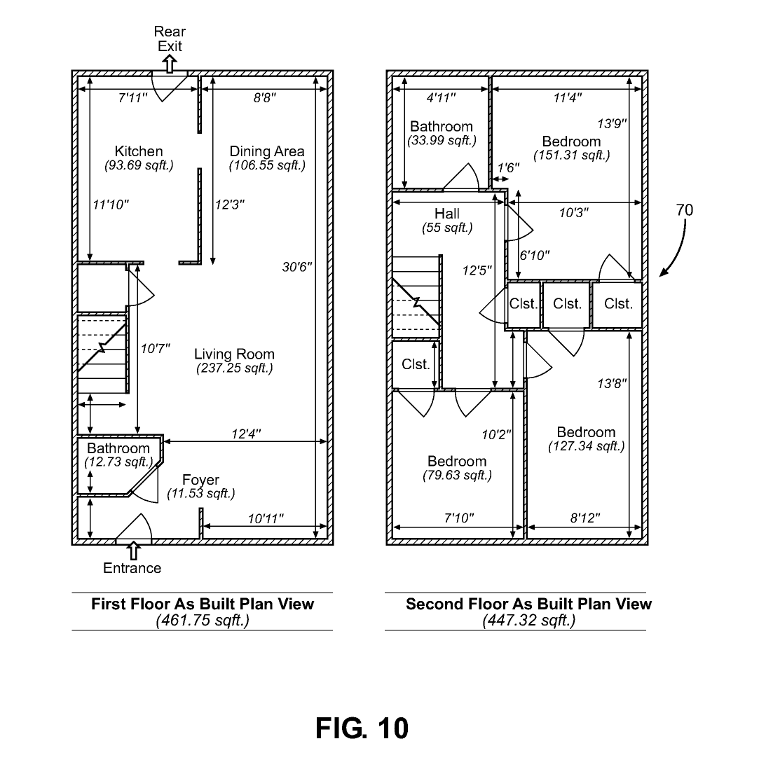

Referring now to FIG. 10, there is shown a sample layout of a given property. The layout 70 of the unit can be input in the system and stored for subsequent retrieval. The layout 70 is helpful for appraisers who may take a physical copy of the layout and make notes about the various amenities and feature factors. This marked copy can be input in the system for later review, while the layout generally serves as additional data that is stored in connection with a specific property on the system. A user of the system can open the layout and make notes via the application layer, marking new amenities or grading specific feature factors based on their location. This may further improve communication with a landlord or property owner who may wish to review the findings of the agency administering the present method.

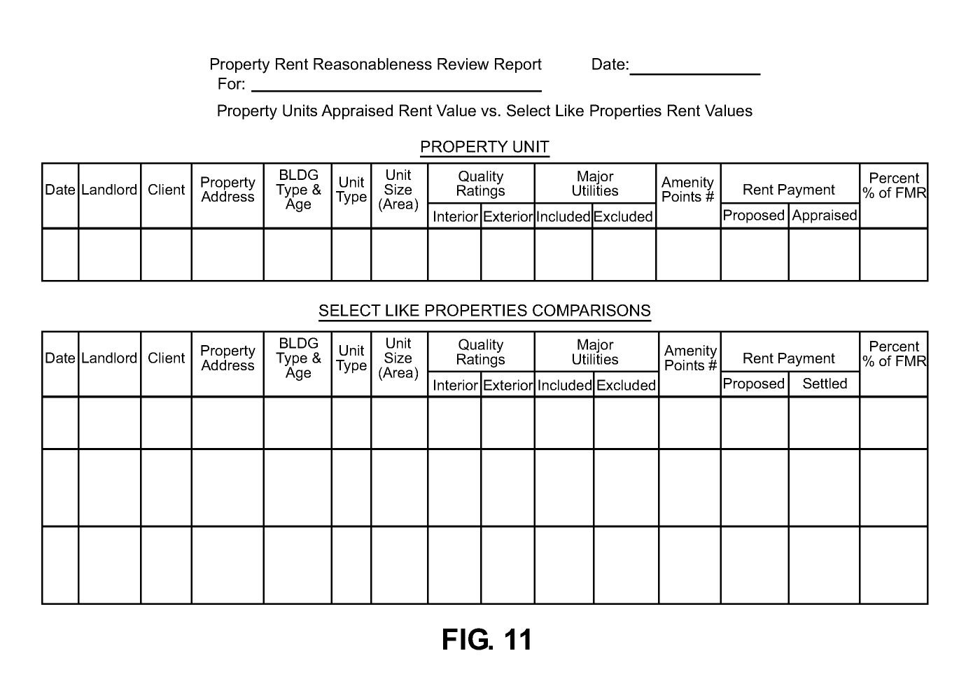

Referring finally to FIG. 11, there is shown a view that illustrates the output of the present invention. This output is a summary table of the estimated rental value after the calculation thereof, whereby the pertinent details of the property are shown and the resulting estimated rent. The calculated estimated rent is then compared to the fair market rent, whereby a user can see the impact of the condition of the property on the rent that should be proposed to the landlord, whereby the amount may be higher or lower than the fair market rent depending on the state of the unit, its amenities, and the utilities thereof. The output can furthermore be compared against adjacent properties or units in a side-by-side comparison, whereby several units can be compared to contrast the differences. The output tables are also helpful during negotiations with the property owner, wherein like properties with greater estimated rental values (but of the same class or type of unit) can be shown to the landlord to incentivize improvements or show data in which serves as a foundation for the estimated rent proposed.

In carrying out the above objects, the present invention contemplates access to an application layer executed on a computer or like programmable apparatus. The computer comprises a non-transitory computer-readable storage medium and computer-readable data on the computer-readable storage medium. The computer-readable data is representative of a database containing textual information for each house. The user inputs or utilizes a network to load property-specific data related to a specific rental property. This includes inputting directly gathered property-specific data related to a specific rental property and loading external property data related to the specific rental property from one or more servers over a network.

Overall, the present method determines rent values for residential housing units or apartments in which tenants receive government housing assistance. The method comprises the steps of collecting specific data, such as building feature factors, fair market rent, utility expenses, number of rooms, property features, etc., and compiling the data on a computer system, whereby the data is compiled through direct entry and derived from external sources via a network. The information is then input in a calculus that provides an estimated residential value for the property, weighting the various factors input in the system against the fair market rent and the utilities of the unit. The estimated rent therefore incorporates the actual condition and quality of the unit, rather than assigning a fair market rent without any real-world consideration of the living conditions of the property. It is therefore submitted that the incorporation of these factors will help to curb inconsistent, rampant, and uncontrolled rental rates, and creates incentives for property owners or landlords to update their properties and improve living conditions for people receiving government housing assistance.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum steps, function and manner of operation, application and use, are deemed readily apparent to those skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of appraising rental property, comprising the steps of:
initiating an application layer executed on a computer or other like programmable apparatus;
inputting directly gathered property-specific data related to a specific rental property;
said property-specific data comprising one or more of the following:
bibliographic data of said specific rental property;
fair market rent;
feature factors;
building factors;
general property factors;
amenities;
utility expenses;
physical layout of said specific rental property;
loading external property data related to said specific rental property from one or more servers over a network;
said external property data comprising one or more of the following:
bibliographic data of said specific rental property;
fair market rent;
feature factors;
building factors;
general property factors;
amenities;
utility expenses;
compiling said property-specific data and said external property data in a database;
using said computer or other like programmable apparatus to calculate an estimated rent for said specific rental property from said property-specific data and said external property data.

2. The method claim 1, wherein said step of using said computer or other like programmable apparatus to calculate further comprises:
determining said estimated rent according to the equation:
$$\sum R = \frac{\sum {R}_{1}}{\sum {F}_{1}} ( i \cdot NFMR ) + \frac{\sum {R}_{2} + \sum {R}_{3}}{\sum {F}_{2} + \sum {F}_{3}} ( e \cdot NFMR ) [ 1 + ( P ) ( 1 \% ) ] + {U}_{0} .$$

3. The method claim 1, wherein said step of inputting property-specific data related to a specific rental property further comprises the steps of:
evaluating said specific rental property to generate said property-specific data.

4. The method claim 1, wherein said step of loading external property data further comprises the steps of:
accessing one or more an external servers storing public or government agency housing data;
requesting said external property data related to a specific rental property;
compiling and loading said external property data related to a specific rental property on said computer or other like programmable apparatus.
